(19) United States
(12) Patent Application Publication
(10) Pub. No.: US 2015/0361382 A1
(43) Pub. Date: Dec. 17, 2015

(54) A METHOD FOR COATING METALLIC SURFACES FOR PREVENTING PINHOLES ON ZINC-CONTAINING METALLIC SURFACES

(71) Applicant: CHEMETALL GMBH, Frankfurt am Main (DE)

(72) Inventors: Martin MROCHEM, Frankfurt am Main (DE); Jürgen SPECHT, Rodgau (DE); Hardy WIETZORECK, Frankfurt am Main (DE); Olaf DAHLENBURG, Neu-Isenburg (DE)

(73) Assignee: CHEMETALL GMBH, Frankfurt am Main (DE)

(21) Appl. No.: 14/766,515

(22) PCT Filed: Feb. 7, 2014
(86) PCT No.: PCT/EP2014/052383

§ 371 Date: Aug. 7, 2015

(30) Foreign Application Priority Data
Feb. 13, 2013 (DE) 10 2013 202 286.7

(51) Int. Cl. C11D 3/37; C09D 183/08

(52) U.S. Cl. CPC C11D 3/3742; C09D 183/08

(57) ABSTRACT

A method of using a silane additive in an aqueous cleaning composition, in an aqueous rinsing liquid and/or in an aqueous activation composition for preventing pinholes on zinc-containing metallic surfaces, wherein the silane content in at least one of these aqueous compositions is in a range of 0.001 to 5 g/l.

The present application relates to methods for coating metallic surfaces for preventing pinholes on zinc-containing metallic surfaces using a silane additive in an aqueous cleaning composition, in an aqueous rinsing liquid and/or in an aqueous activation composition.

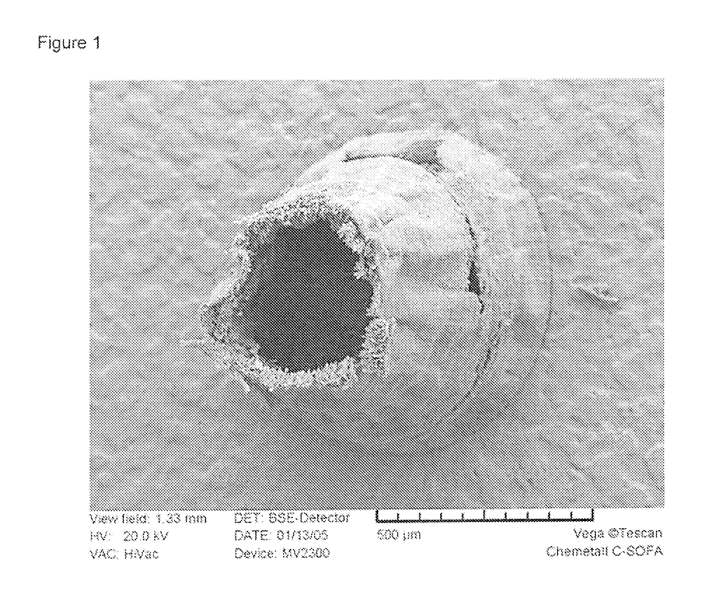

The terms “pinholes” or “white spots” as used herein refer to small faults on the surfaces of zinc and zinc alloys, which may e.g. be caused by a locally increased pickling rate on the zinc-rich metallic surface or by using a phosphating solution with excessively high contents of chloride ions and/or nitrate ions. They may occur in particular in the case of prolonged treatment times. Pinholes are white or bright corrosion points on the metallic surface which under a microscope look like a crater. In extreme situations, the crater-shaped pinholes may protrude from the metallic surface by as much as approx. 1 mm, and the zinc-containing coating of e.g. a hot-galvanised surface may be more or less dissolved within the crater-shaped pinhole. Pinholes formed in a cleaning bath may be more flat and may, if present, have a diameter of several millimetres. FIG. 1 shows a particularly large pinhole in a raster electron microscope image on a galvanised and subsequently zinc-phosphated metallic surface, which protrudes from the coated surface to a height of approx. 1 mm, and on the inside of which the zinc coating is largely dissolved. Pinholes may be the starting point for greater damage by corrosion because the protective zinc or zinc alloy layer is substantially damaged in the area of the pinhole, and they may be a starting point for greater damage as a result of delamination of the coating laminated thereon. Therefore, even one single pinhole is disturbing, and for this reason pinholes should be altogether avoided in industrial practice.

However, for decades and despite increased experience in the prevention of pinholes, the problem of the formation of pinholes due to impurities in the bath and due to the use of metallic substrates with increased proportions of impurities still exists. They may occur as bright crater-shaped faults in a crystalline phosphate layer and may still be visible as elevations or marks on the varnished surface even after varnishing with one or even multiple varnish layers. Therefore, the presence of pinholes quickly leads to a post-processing of e.g. the phosphated metallic surfaces, which may, if necessary, also be coated with electrodeposition paint or powder paint, with another varnish and/or with a clear varnish. Post-processing is carried out in particular by levelling these parts in the area around the faulty site, e.g. by grinding or sandblasting and possibly by machining it down to the metallic surface, and can subsequently again be leveled by way of a post-processing such as e.g. by phosphating and with one or multiple varnish layers. Due to the fact that such repair works often occur in a car body coating line in vehicle construction and are in most cases carried out by hand, the expenditure in terms of time and labour is very high.

Pinholes are often not detected until at the end of a treatment line after conversion coating or even at the end of the further coating with an electrodeposition paint, a powder paint or a primer or are felt by the hand as unevenness. Larger pinholes can be detected on clean metallic surfaces, on rinsed metallic surfaces, on activated metallic surfaces or on conversion-coated, such as e.g. phosphate, metallic surfaces only under certain conditions, once the treated substrates have been taken out of the bath.

A typical treatment line during phosphating may comprise for example at least one cleaning zone with an aqueous cleaning composition, at least one rinsing zone with an aqueous rinsing liquid and, if necessary, at least one zone for activation prior to phosphating with an aqueous activation composition A) or B), and thereafter zones for phosphating and for at least one more rinsing process with an aqueous rinsing liquid, if necessary before at least one zone for at least one varnishing process.

Another typical treatment line may for example comprise at least one cleaning zone with an aqueous cleaning composition, at least one rinsing zone with an aqueous rinsing liquid and at least one zone for treatment or pre-treatment using a silane-containing aqueous composition for conversion coating and, if necessary, subsequently at least one rinsing zone with an aqueous rinsing liquid and, if necessary, also zones for at least one varnishing process.

Generally, a typical treatment line may comprise for example at least one cleaning zone with an aqueous cleaning composition, at least one rinsing zone with an aqueous rinsing liquid and at least one zone for treatment or pre-treatment using an aqueous composition for conversion coating and, if necessary, after that at least one rinsing zone with an aqueous rinsing liquid and, if necessary, also at least one zone for at least one varnishing process. In practice, a zone is equivalent with a stage.

However, the prior art proposals for preventing pinholes relate to the phosphating conditions and to the composition of the zinc phosphating solution. In industrial practice, a nitrite of an aqueous cleaning composition, of an aqueous rinsing liquid and/or of an aqueous activation composition were added as needed, in order to reduce or prevent the formation of pinholes. However, nitrites are toxic additives and can if present rapidly decompose, so that they have to be quickly replenished.

However, it was observed that pinholes are formed on metallic surfaces of zinc and zinc alloys often as early as prior to the phosphating and may often also occur in conversion coatings that are unlike zinc phosphating.

The reason is that pinholes may be formed as early as in an aqueous cleaning composition, in an aqueous rinsing liquid and/or in an aqueous activation composition prior to phosphating or prior to a different kind of conversion coating. In these situations, the measures for zinc phosphating as mentioned in the prior art are of no or of only limited value.

If metallic surfaces are to be coated and have not just been hot galvanised, it is customary to clean, in particular to degrease, the metallic surfaces first in an aqueous cleaning composition. To this end, in particular an acidic, neutral, alkaline or strongly alkaline cleaning composition but, if necessary, in addition also an acidic pickling composition may be used. Apart from at least one surfactant, the aqueous cleaning composition may also contain, if necessary, a cleaner backbone and/or other additives such as e.g. complexing agents.

Between the cleaning and the activating, usually at least one rinsing process with water is carried out, and if necessary also an additive dissolved in water, such as e.g. a nitrite, may be added to the water if needed.

An activation composition is usually used only prior to manganese phosphating or prior to zinc phosphating, wherein manganese or zinc constitutes the predominantly present cation, and wherein if necessary further cations that play a subordinate role may be contained. The activation composition is used to deposit a plurality of ultrafine phosphate particles as seed crystals onto the metallic surface, which aid in the subsequent process step of forming, in contact with the phosphating solution, an in particular crystalline phosphate layer with a maximum possible number of fine phosphate crystals, which are arranged closely to each other, or a largely closed phosphate layer. Particularly preferred is the use of a silane additive in at least one aqueous composition according to the invention of a bath or of a zone prior to alkaline phosphating, prior to manganese phosphating or prior to zinc phosphating.

A phosphating solution for phosphating, which can be carried out following activation, may, apart from the cations and apart from an orthophosphate content, in particular have a content of condensed phosphate, nitrate, fluoride, complex fluoride, organic polymer and/or accelerator such as e.g. an accelerator on the basis of nitrite, chlorate, peroxide and/or nitro compounds such as e.g. nitroguanidine.

The so far most widely used methods for treating (=passivating) metallic surfaces, in particular of parts, strip (coil) and/or strip sections from at least one metallic material or for pre-treating metallic surfaces prior to a further coating such as e.g. varnishing metallic surfaces, are often based on the use of aqueous phosphating solutions such as e.g. zinc-manganese-nickel-phosphating solutions, and, for a number of years now, also increasingly on the use of silane-containing solutions. Apart from at least one silane, silanol and/or siloxane, these aqueous and/or alcoholic silane-containing solutions each contain, if necessary, also an additive of organic polymer/copolymer, cations, fluoride, complex fluoride, silicate and/or of further additives such as e.g. an accelerator. Frequently, a mixture of various metallic materials such as e.g. on the basis of steel, galvanised steel, zinc alloy galvanised steel and/or aluminium alloy is treated or pretreated in such a bath. Therefore, high demands are frequently placed on multi-metal applications, which due to the chemically varying conditions, cannot readily be equally well used for all material variants of the metallic surfaces.

The treatment or pre-treatment with a conversion composition may if necessary, in particular after rinsing with water, be followed by a treatment with a post-rinsing solution, which may, if necessary, be followed by rinsing with water. Frequently, electrophoretic painting using electrodeposition paint such as e.g. a cathodic electrodeposition paint (KTL, e-Coat), a primer or a powder varnish is used as the first varnish coating after a pre-treatment.

It was therefore the object of the invention to propose a method that allows the formation of pinholes to be suppressed or prevented in an aqueous cleaning composition, in an aqueous rinsing liquid and/or in an aqueous activation composition. It would be of advantage here if also any marks that might later develop in the varnish, could be prevented using this method. It would also be of advantage here if this method could be implemented in a simple manner. It would also be advantageous if the method according to the invention was also suitable for multi-metal applications, in which e.g. steel and zinc-rich metallic surfaces and, if necessary, also aluminium-rich metallic surfaces are treated or pretreated in the same bath.

It has now surprisingly been found that a silane additive allows the formation of pinholes to be suppressed or to be prevented, if a content of silane is added a) to the aqueous cleaning composition, b) to the aqueous rinsing liquid and/or c) to the aqueous activating composition prior to the phosphating. Moreover, it has now been shown that also faults such as strip-shaped marks and dusty coverings on conversion-coated metallic surfaces, which will often not show until after the conversion coating, can be reduced or even prevented using a silane additive.

This object is achieved by using a silane additive for preventing pinholes on zinc-containing metallic surfaces 1) in an aqueous cleaning composition, 2) in an aqueous rinsing liquid, which is used a) prior to a cleaning process, b) amidst a plurality of cleaning zones, c) immediately after cleaning and/or d) as a liquid for cooling, and/or 3) in an aqueous activation composition, wherein the content of in each case at least one silane, silanol and/or siloxane in at least one of these aqueous compositions is in a range of 0.001 to 5 g/L, calculated in relation to the respective silane. The silane is here regarded as the starting compound of the reaction chain of e.g. silane via silanol to siloxane.

It therefore also relates to the use of a silane additive for preventing pinholes on zinc-containing metallic surfaces 1) in an aqueous cleaning bath, 2) in an aqueous rinsing bath, the liquid of which is used a) prior to a cleaning process, b) amidst a plurality of cleaning zones, c) immediately after a cleaning process and/or d) for cooling, and/or 3) in an aqueous activation bath, wherein the content of in each case at least one silane, silanol and/or siloxane in at least one of these aqueous baths is in a range of 0.001 to 5 g/L, calculated in relation to the respective silane. In variants 2) c) and d), it is also possible to use in each case a plurality of rinsing zones after the cleaning and/or after the cooling. The term “cooling” comprises here, if necessary, also quenching.

If a silane additive is used for preventing pinholes on zinc-containing metallic surfaces 1) in the aqueous cleaning composition of a cleaning zone, 2) in the aqueous rinsing liquid of a rinsing zone, the liquid of which is used a) prior to a cleaning process, b) amidst a plurality of cleaning zones, c) immediately after a cleaning process, and/or d) for cooling, and/or 3) in the aqueous activation composition of an activation zone of a treatment line, the content of in each case at least one silane, silanol and/or siloxane in at least one of these zones is preferably in a range of 0.001 to 5 g/L, calculated in relation to the respective silane. A cleaning process may comprise for example one to three zones and, if necessary, also a rinsing zone in between. A rinsing process may be carried out for example in one to four zones, e.g. after a cleaning process. Also a spray ring is understood to be a zone. Activation is usually carried out only in one zone.

The term “silane” or “silane additive” comprises silane, silanol and/or siloxane, as will be explained in more detail below.

The term “bath” in terms of the present application is therefore equivalent with “composition” and, if applicable, also with “zone”, because this composition may be used both in the bath of a step carried out on its own and in a bath of a zone of a treatment line. The bath in terms of the present application can be used as a bath in a container and/or as a bath e.g. by spraying singularly e.g. in a laboratory or in a zone of a treatment line.

The term “rinsing” or “rinse” in terms of the present application also comprises contacting with water, e.g. by submersion in a bath that is located in a container.

A treatment line may comprise in particular baths with an aqueous composition for cleaning using a cleaning composition, for rinsing using an aqueous rinsing liquid, for activating using an aqueous activation composition, for passivating or pretreating using a conversion composition for passivating or for pretreating such as e.g. a phosphating solution, or e.g. substantially on the basis of metal cations, phosphate, fluorine compound, silane, silicate, complexing agent and/or organic polymer/copolymer. Passivation or treatment in a strict sense is understood to be a treatment without a further coating carried out in the foreseeable future, e.g. with at least one organic composition of an adhesive, primer and/or varnish.

Particularly preferred is the use of a silane additive in at least one aqueous composition of a bath or of a zone in particular for cleaning, rinsing and/or activating A) prior to a phosphating process or for cleaning and/or rinsing, B) prior to a passivation or pre-treatment using an aqueous conversion composition with a content of fluoride and/or of titanium, hafnium and/or zirconium complex fluoride, of silane, of metal cations such as manganese, of organic polymer/copolymer and/or of at least one additive or C) prior to an alkaline, neutral or acidic aqueous passivation with a content of metal cations, complex fluoride, oxide, phosphate, silane, silicate, organic polymer/copolymer and/or at least one additive. The corresponding conversion compositions are in principle known.

The cleaning according to the invention using an aqueous silane-containing cleaning liquid may in particular be carried out using an aqueous neutral, alkaline or highly alkaline cleaning composition with a content of at least one surfactant and, if applicable, also with a content of cleaner backbone and/or other additives such as e.g. complexing agents.

Rinsing using an aqueous silane-containing rinsing liquid according to the invention in particular relates to rinsing a) prior to a cleaning process, b) during a cleaning process, c) after a cleaning process with at least one aqueous cleaning composition and/or d) for cooling in each case with at least one aqueous rinsing liquid as well as, if necessary, also rinsing e) immediately prior to and/or f) immediately after an activation with an aqueous activation composition and/or rinsing g) prior to conversion coating, which means prior to passivation or prior to a pre-treatment using an aqueous conversion composition. In this context, if necessary individual ones of these rinsing steps a) to g) may coincide. Treatment=passivation and pre-treatment are combined under conversion coating. The treatment composition=passivation composition and the pre-treatment composition are combined under conversion compositions, and correspondingly also the baths, zones and similar terms are combined in an analogous manner. The term “bath” is to be regarded, in terms of the present application, as an aqueous composition or an aqueous liquid.

The activation according to the invention using an aqueous silane-containing activation composition in particular relates to an activation using an aqueous activation composition as a so-called surface conditioner with a pH value in the range of 3 to 12 on the basis of water-insoluble particles of orthophosphates of di- and/or trivalent metals having an average particle grain size of up to 3 μm or activating using an aqueous activation composition on the basis of colloidal titanium phosphate, at least one orthophosphate dissolved in water or soluble in water and, if necessary, at least one condensed phosphate.

The aqueous cleaning composition according to the invention may also, if necessary, be combined with another process step such as e.g. activating, alkali-phosphating or passivating and will then contain at least one corresponding further substance of that process step, as a result of which a shortened and simplified procedure may be achieved. Such compositions are referred to, in terms of the present application, as aqueous cleaning compositions.

The content of the aqueous cleaning composition (=cleaning bath) according to the invention, of the aqueous rinsing liquid (=rinsing bath) according to the invention and/or of the aqueous activation composition (=activation bath) of in each case at least one silane, silanol and/or siloxane is 0.001 to 5 g/L, calculated in relation to the respective silane. Preferably, the content of in each case at least one silane, silanol and/or siloxane in at least one of these bath compositions is in each case 0.005 to 4.5 g/L, 0.01 to 4 g/L, 0.015 to 3 g/L, 0.02 to 2.5 g/L, 0.03 to 2 g/L, 0.05 to 2 g/L, 0.07 to 1.5 g/L, 0.09 to 1.2 g/L, 0.12 to 1 g/L, 0.2 to 0.8 g/L or 0.4 to 0.6 g/L, calculated in relation to the respective silane. First attempts indicate that silane contents in a range of 0.05 to 1 g/L in at least one of these bath compositions are particularly preferred.

The term “silane” in terms of the present application is supposed to mean that a silicon-containing compound is added or has been added, which was originally based on a silane and may be present, as a result of its use in water and under the conditions of the use of the corresponding aqueous composition, as silane, silanol and/or siloxane. The term “silane” is here used for “silanes, silanols and/or siloxanes”, which are here also frequently “silane” mixtures.

Usually it is assumed here that silane is added, wherein the added at least one silane is often at least partially hydrolysed, and it often forms at least one silanol during the initial contact with water or humidity, from which at least one siloxane and later, if necessary, also at least one polysiloxane is or may be formed. The term “condensing” in terms of the present application refers to all types of crosslinking, further crosslinking and the further chemical reactions of the silanes via silanols into siloxanes and, if necessary, in a very thin layer on the metallic surface after drying possibly also into polysiloxanes. In this case, a multiplicity of silicon-containing compounds may form, in particular a larger number of chemically similar compounds including the compounds with different molecular sizes due to different degrees of condensation, which may also lead to the formation of a very thin layer, so that often a plurality of similar compounds may also be present in this layer.

In the past, a silane was either not, or only under very rare circumstances, added to aqueous compositions, because a silane was regarded as a crosslinking agent, a binder, a conversion agent, a reactive substance for organic polymers/copolymers and/or, in exceptions, also as a stabilising agent, so that silanes were added only to conversion compositions in particular of the second type as well as to primers and varnishes. The silane was then often only used for modifying those substances or compositions that contained e.g. organic polymers/copolymers as the main component or as a silane crosslinking agent, if necessary also as a main component for producing a particularly corrosion-resistant and adhesion-promoting conversion coating.

During the manufacture of an aqueous composition according to the invention, special care has to be taken to ensure that the silanes, silanols and/or siloxanes added to the aqueous composition are homogeneously distributed, if necessary by agitation, in order to achieve a homogeneous distribution. It may therefore be advantageous to use silanes, silanols and/or siloxanes that are highly soluble in water, in particular those with a water solubility at 20° C. of more than 5 g/L.

It is particularly preferred if during the production of an aqueous silane-containing composition according to the invention, in each case at least one silane, silanol and/or siloxane with at least one alkoxy group, with at least one amido group, with at least one amino group, with at least one urea group and/or with at least one imino group is added and is then contained in the aqueous silane-containing composition.

It is particularly preferred if during the production of an aqueous silane-containing composition according to the invention, in each case at least one alkoxy silane, alkoxy silanol and/or alkoxy siloxane with at least one amido group, with at least one or with at least two amino groups, with at least one urea group and/or with at least one imino group is added and is then contained in the corresponding aqueous silane-containing composition.

It is particularly preferred if during the production of an aqueous silane-containing composition according to the invention, in each case at least one alkoxy silane, alkoxy silanol and/or alkoxy siloxane with at least one amido group, with at least one amino group, with at least one urea group and/or with at least one imino group per molecule is added and is then contained in the corresponding aqueous silane-containing composition.

It is particularly preferred if during the production of an aqueous silane-containing composition according to the invention, in each case at least one silane, silanol and/or siloxane with at least two amino groups, with at least three amino groups, with at least four amino groups, with at least five amino groups and/or with at least six amino groups per molecule and/or with at least two, at least three or more than three alkoxy groups per molecule is added and is then contained in the corresponding aqueous silane-containing composition.

It is particularly preferred if during the production of an aqueous silane-containing composition according to the invention, in each case at least one alkoxy silane, alkoxy silanol and/or alkoxy siloxane with at least two amido groups, with at least two amido groups, with at least two urea groups and/or with at least two imino groups per molecule is added and is then contained in the corresponding aqueous silane-containing composition.

It is particularly preferred if during the production of an aqueous silane-containing composition according to the invention, in each case at least one alkoxy silane, alkoxy silanol and/or alkoxy siloxane with two, three or more than three amino groups per molecule is added and is then contained in the corresponding aqueous silane-containing composition.

Particularly preferably, the aqueous silane-containing composition includes a content of in each case at least one silane, silanol and/or siloxane with in each case at least one group per molecule, selected from amino alkyl groups, alkyl amino alky groups, amino alkyl amino alkyl groups and/or alkyl amino groups.

Particularly preferred here is at least one silane and/or at least one corresponding silanol and/or siloxane from the following list on the basis of:
3-[2-(2-aminoalkylamino)alkylamino]alkyltrialkoxysilane,
4-amino-dialkylalkyltrialkoxysilane,
4-amino-dialkylalkylalkyldialkoxysilane,
aminoalkylaminoalkyltrialkoxysilane,
aminoalkylaminoalkylalkyldialkoxysilane,
aminoalkyltrialkoxysilane,
bis-(trialkoxysilylalkyl)amine,
bis-(trialkoxysilyl)ethane,
gamma-aminoalkyltrialkoxysilane,
gamma-(trialkoxysilylalkyl)dialkylene triamine,
gamma-ureidoalkyltrialkoxysilane,
N-2-aminoalkyl-3-aminoproplyltrialkoxysilane,
N-(3-(trialkoxysilyl)alkyl)alkylene diamine,
N-alkylaminoisoalkyltrialkoxysilane,
N-(aminoalkyl)aminoalkylalkyldialkoxysilane,
N-beta-(aminoalkyl)-gamma-aminoalkyltrialkoxysilane,
N-(gamma-trialkoxysilylalkyl)dialkylene triamine and/or
poly(aminoalkyl)alkyldialkoxysilane,
   wherein in particular such components from this list are particularly preferred, in which the alkyl group is independently from each other a methyl, ethyl and/or propyl group.

Particularly preferred is the use of a silane additive in an aqueous composition for preventing pinholes on zinc-containing metallic surfaces, selected from 1) an aqueous cleaning composition, 2) an aqueous rinsing liquid—in particular in a rinsing liquid for cooling, and/or before, during and/or after a cleaning process in an aqueous cleaning composition with or without a silane additive and, if necessary, prior to an activation in an aqueous activation composition, and/or 3) from an aqueous activation composition prior to phosphating, or that during the production of an aqueous silane-containing composition, in each case at least one silane, silanol and/or siloxane selected from the following silane compounds is added in a range of 0.001 to 5 g/L, calculated in relation to the respective silane, and is then contained in the corresponding aqueous silane-containing composition in a range of 0.001 to 5/μL, calculated in relation to the respective silane, and
a) that during the production of an aqueous silane-containing composition according to the invention, in each case at least one silane, silanol and/or siloxane in each case with at least one group per molecule selected from alkoxy groups, amido groups, amino groups, urea groups and imino groups is added and is then contained in the corresponding aqueous silane-containing composition,
b) and that during the production of an aqueous silane-containing composition according to the invention, in each case at least one silane, silanol and/or siloxane selected from the following silane compounds is added and is then contained in the corresponding aqueous silane-containing composition:
3-[2-(2-aminoalkylamino)alkylamino]alkyltrialkoxysilane,
4-amino-dialkylalkyltrialkoxysilane,
4-amino-dialkylalkylalkyldialkoxysilane,
aminoalkylaminoalkyltrialkoxysilane,
aminoalkylaminoalkylalkyldialkoxysilane,
aminoalkyltrialkoxysilane,
bis-(trialkoxysilylalkyl)amine,
bis-(trialkoxysilyl)ethane,
gamma-aminoalkyltrialkoxysilane,
gamma-(trialkoxysilylalkyl)dialkylene triamine,
gamma-ureidoalkyltrialkoxysilane,
N-2-aminoalkyl-3-aminoproplyltrialkoxysilane,
N-(3-(trialkoxysilyl)alkyl)alkylene diamine,
N-alkylaminoisoalkyltrialkoxysilane,
N-(aminoalkyl)aminoalkylalkyldialkoxysilane,
N-beta-(aminoalkyl)-gamma-aminoalkyltrialkoxysilane,
N-(gamma-trialkoxysilylalkyl)dialkylene triamine and/or
poly(aminoalkyl)alkyldialkoxysilane,
   wherein the alkyl groups independently from each other represent a methyl, ethyl and/or propyl group, and/or
   c) that during the production of an aqueous silane-containing composition according to the invention, in each case at least one silane, silanol and/or siloxane selected from silane compounds on the basis of bis(trialkoxysilylpropyl)amine, on the basis of N-(3-(trialkoxysilyl)propyl)ethylene diamine and/or on the basis of 3-[2-(2-aminoalkylamino)alkylamino]propyltrialkoxysilane is added and is then contained in the corresponding aqueous silane-containing composition.

If at least one of these silanes such as e.g. selected from the first list provided above is used, care has to be taken that the hydrolysis and the commencing condensation may partially take place very rapidly. In many cases it is preferred to hydrolyse the silanes to be added prior to the adding. If silanol is already present in an aqueous solution, siloxanes may often also rapidly occur.

### 1) Cleaning Compositions, Cleaning Baths:

Preferably, the aqueous cleaning composition according to the invention has a pH value in a range of 3 to 14, of 5 to 13.5, of 6 to 13 or of 7 to 12. The composition of the cleaning baths is, with the exception of the silane content, in principle known. Preferably, it contains at least one surfactant with an overall surfactant content in a range of 0.01 to 10 g/L, wherein preferably at least one non-ionic surfactant is used and wherein, if necessary, also in each case at least one anionic, cationic and/or amphoteric surfactant may be included.

What is preferred is the use of a silane additive in an aqueous cleaning composition according to the invention with a pH value in a range of 3 to 14, which has an overall surfactant content in a range of 0.1 to 10 g/L and contains at least one non-ionic surfactant.

If necessary, it will also include a cleaner backbone with an overall content in a range of 0.01 to 100 g/L. The cleaner backbone is preferably one having at least two substances selected from those on the basis of complexing agents, solubility promoters, silicate, potassium hydroxide, sodium hydroxide, borate, carbonate, orthophosphate, alkanolamine and/or condensed phosphate. As complexing agents, particularly those on the basis of carboxylic acid, phosphonic acid and/or phenol compounds, in particular those on the basis of amino carboxylic acid, hydroxy carboxylic acid, polycarboxylic acid, polyoxycarboxylic acid, phosphonic acid, amino phosphonic acid, hydroxy phosphonic acid, tannin and/or gallic acid may be used, particularly preferred are those on the basis of citrate, gluconate, glucoheptonate, heptonate and/or 1-hydroxyethane-(1,1-diphosphonic acid). As solubility promoters, if necessary at least one component e.g. selected from cumolsulfonates, phosphonic acid esters, salts of a carboxylic acid and/or polyvalent alcohols may be used. As metal cations, apart from alkaline metal ions, if necessary also heavy metal ions such as e.g. ferrous ions may be added. Moreover, impurities in a range of 0.001 to 20 g/L often occur, in particular often anionic impurities such as e.g. oil components.

Particularly preferred is the use of a silane additive in an aqueous cleaning composition according to the invention having a content of heavy metal ions such as e.g. ferrous ions and a complexing agent, or in an aqueous cleaning composition and/or in an aqueous rinsing liquid prior to treatment with an aqueous passivation composition with a content of complexing agent and metal ions such as e.g. aluminium and/or heavy metal ions such as e.g. chrome(III), iron, manganese and/or zinc.

If a silane is added to an aqueous cleaning composition, care has to be taken to ensure that this silane is compatible with the corresponding pH value, which in the case of most aqueous cleaning compositions does not require any measures.

### 2) Rinsing Liquid, Rinsing Bath:

Preferably, the aqueous rinsing liquid according to the invention has a pH value in a range of 3 to 14, of 5 to 13.5, of 6 to 13 or of 7 to 12. The rinsing bath will often include water of mains water grade, but it may also be based on other water grades such as e.g. demineralised water. The rinsing liquid may, if necessary, also have added thereto at least one further substance, in particular at least one surfactant, portions of a cleaner backbone, at least one amine, one nitrite and/or at least one complexing agent, wherein the added amounts are each preferably in a range of 0.001 to 5 g/L. The composition of the rinsing baths is, with the exception of the silane content, in principle known.

Moreover, the rinsing liquid may also contain components entrained during use, in particular those from a previous cleaning zone, so that it will then often contain at least one surfactant having an overall surfactant content in a range of 0.001 to 5 g/L, wherein often at least one non-ionic surfactant occurs and wherein, if necessary, in each case also at least one anionic, cationic and/or amphoteric surfactant may be included. If necessary, the aqueous rinsing liquid may also contain a cleaner backbone in an overall amount in a range of 0.001 to 30 g/L. The cleaner backbone will then in particular be one having at least two substances selected from those on the basis of complexing agents, solubility promoters, silicate, potassium hydroxide, sodium hydroxide, borate, carbonate, orthophosphate, alkanolamine and/or condensed phosphate. As complexing agents, in particular those may occur that are based on carboxylic acids, phosphonic acids and/or phenol compounds, in particular those on the basis of amino carboxylic acid, hydroxy carboxylic acid, polycarboxylic acid, polyoxycarboxylic acid, phosphonic acid, amino phosphonic acid, hydroxy phosphonic acid, tannin and/or gallic acid, particularly preferably those on the basis of citrate, gluconate, glucoheptonate, heptonate and/or 1-hydroxyethane-(1,1-diphosphonic acid). As solubility promoters, if necessary, also at least one compound may be present, which is e.g. selected from cumolsulfonates, phosphonic acid esters, salts of a carboxylic acid and/or polyvalent alcohols. Moreover, impurities in a range of 0.001 to 5 g/L often occur during use, in particular often anionic impurities such as e.g. oil components.

The conductivity of the aqueous rinsing liquid is preferably in a range of 1 to 20,000 μS/cm, particularly in a range of 10 to 6,000 μS/cm, and mostly in a range of 200 to 4,000 μS/cm, wherein the values are higher in particular if the rinsing liquid contains at least one additive and/or e.g. is contaminated with proportions from a cleaner.

A quenching bath or a cooling bath, e.g. after hot galvanising or after annealing, is also regarded as a rinsing bath with an aqueous rinsing liquid in terms of the present invention.

If a silane is added to an aqueous rinsing liquid, care has to be taken to ensure that this silane is compatible with the corresponding pH value, which in the case of most aqueous rinsing liquids does not require any measures.

### 3) Activation Composition, Activation Bath:

Preferably, the aqueous activation composition according to the invention has a pH value in a range of 3 to 14, of 5 to 13.5, of 6 to 13 or of 7 to 12. The composition of the activation baths, with the exception of the silane content, is in principle known.

In principle, there are two different kinds of activation compositions:

A) Activation compositions on the basis of Me^{2+/3+} phosphate particles, which are often obtained by grinding and which may often have an average particle grain size of up to 3 μm and, if necessary, a content of further substances such as e.g. dispersing agents or such as e.g. polyacrylate, polycarboxylic acid and/or polycarboxylate ether, copolymer, phosphonic acid, thickening agents, surfactants and/or additives such as e.g. a biocide.

B) Activation compositions on the basis of colloidal titanium phosphate and orthophosphate dissolved or soluble in water, which often additionally contain condensed phosphate, surfactant, stabilising agent, thickening agent and/or a biocide.

### Regarding A) Activation Compositions on the Basis of Phosphate Particles:

EP 1 566 466 B1 teaches activation compositions on the basis of phosphate particles of di- and/or trivalent cations with an average particle grain size of up to 3 μm and with a copolymer having a carboxyl group content. EP 1 930 475 A1 describes aqueous activation compositions on the basis of Me^{2+/3+} phosphate particles with an average particle grain size of up to 3 μm, which have a content of “silane alkoxide”, Ti alkoxide and/or Al alkoxide as well as a stabiliser.

Moreover, the activation composition may also contain components entrained during use, in particular those from a previous cleaning zone and/or from a previous rinsing zone, so that it will then often contain at least one surfactant with an overall surfactant content in a range of 0.001 to 5 g/L, wherein often at least one non-ionic surfactant occurs and wherein, if necessary, also in each case at least one anionic, cationic and/or amphoteric surfactant may be included. If necessary, the aqueous activation composition may also contain a cleaner backbone with an overall content in a range of 0.001 to 30 g/L. The cleaner backbone will then particularly be one with at least two substances selected from those on the basis of complexing agents, solubility promoters, silicate, potassium hydroxide, sodium hydroxide, borate, carbonate, orthophosphate, alkanolamine and/or condensed phosphate. As complexing agents, in particular those based on carboxylic acid, phosphonic acid and/or phenol compounds, in particular those on the basis of amino carboxylic acid, hydroxy carboxylic acid, polycarboxylic acid, polyoxycarboxylic acid, phosphonic acid, amino phosphonic acid, hydroxy phosphonic acid, tannin and/or gallic acid, particularly preferably those on the basis of citrate, gluconate, glucoheptonate, heptonate and/or 1-hydroxyethane-(1,1-diphosphonic aid) may occur. As a solubility promoter, if necessary also at least one compound e.g. selected from cumolsulfonates, phosphonic acid esters, salts of a carboxylic acid and/or polyvalent alcohols may be present. Moreover, often impurities in a range of 0.001 to 5 g/L occur during use, in particular often anionic impurities such as e.g. oil components.

The aqueous activation composition A) according to the invention preferably contains 0.01 to 20 g/L of Me^{2+/3+} phosphate particles having an average particle grain size of up to 3 μm, if necessary at least one dispersing agent, stabilising agent and/or thickening agent such as e.g. those on the basis of amines, phenol compounds, phytic acid, phosphonic acid, polyphosphoric acid, resins with phosphonic groups, polyacrylate, copolymer including carboxylate groups, vinyl resin, saccharide, polycarboxylic acid, polycarboxylate ether, Al alkoxide, Ti alkoxide, polyamino acid, phosphoric acid ester and/or sheet silicate such as e.g. on the basis of hectorite in a range of 0.001 to 40 g/L, if necessary nitrite as well as, if necessary, at least one further additive such as e.g. a biocide in a range of 0.001 to 2 g/L.

Particularly preferred is the use of a silane additive for preventing pinholes on zinc-containing metallic surfaces in an aqueous activation composition A) according to the invention on the basis of metal phosphate particles of di- and/or trivalent metals, in particular of metal orthophosphate particles of di- and/or trivalent metals, having an average particle grain size of up to 3 μm and at least one further substance selected from dispersing agents, thickening agents, surfactants and additives such as e.g. biocides.

If a silane is added to an aqueous activation composition A), care has to be taken to ensure that this silane is compatible with the corresponding pH value, which in the case of most aqueous activation compositions does not require any measures.

### Regarding B) Activation Compositions on the Basis of Colloidal Titanium Phosphate:

WO 2010/066765 A1 teaches methods for phosphating metallic surfaces, wherein the metallic surfaces are treated prior to phosphating with an aqueous colloidal activation agent on the basis of titanium phosphate prior to phosphating, as well as corresponding activation agents, in order to extend the stability period of the activation agent during use and in order to enhance the temperature stability during activation prior to phosphating. As an additive, only two alkoxy silanes with at least one organic group have proven useful in the examples, namely bis(3-triethoxysilylpropyl)amine (=silane type 2) and above all bis(3-trimethoxysilylpropyl)amine (=silane type 1), but no other silane such as e.g. triamino functional silane. DE 37 31 049 A1 discloses methods for producing activating titanium phosphates for zinc phosphating by reacting a titanium compound with simple or condensed phosphates in an aqueous phase using titanium(IV) compounds under the conditions of hydrothermal synthesis with water-soluble phosphates and under full drying for producing powdery activation agents. EP 0 454 211 A1 relates to methods for applying phosphate coatings onto metal surfaces by activation with an activation agent on the basis of titanium, orthophosphate, copper and alkali metal as well as by zinc phosphating.

The aqueous activation composition B) according to the invention preferably contains 0.001 to 10 g/L of in particular colloidal titanium phosphate, 0.005 to 30 g/L of orthophosphate dissolved in water, if necessary at least one condensed phosphate in a range of 0.001 to 30 g/L, often at least one surfactant in a range of 0.005 to 5 g/L, if necessary thickening agents such as e.g. on the basis of a biopolymer, if necessary stabilising agents such as e.g. on the basis of maleic acid anhydride copolymer and if necessary 0.001 to 2 g/L of biocide.

Particularly preferred is the use of a silane additive for preventing pinholes on zinc-containing metallic surfaces in an aqueous activation composition B) according to the invention on the basis of 0.001 to 10 g/L of in particular colloidal titanium phosphate, of 0.005 to 30 g/L of orthophosphate dissolved in water and of at least one further substance selected from condensed phosphates, surfactants, stabilising agents, thickening agents and biocides.

Moreover, the activation composition may also contain components entrained during use, in particular those from a previous cleaning zone and/or from a previous rinsing zone, so that they will then often contain at least one surfactant having an overall surfactant content in a range of 0.001 to 5 g/L, wherein often at least one non-ionic surfactant occurs and wherein, if necessary, also in each case at least one anionic, cationic and/or amphoteric surfactant may be included. If necessary, the aqueous activation composition may also contain a cleaner backbone with an overall content in a range of 0.001 to 30 g/L. The cleaner backbone will then in particular be one with at least two substances selected from those on the basis of complexing agents, solubility promoters, silicate, potassium hydroxide, sodium hydroxide, borate, carbonate, orthophosphate, alkanolamine and/or condensed phosphate. As a complexing agent, in particular those on the basis of carboxylic acid, phosphonic acid and/or phenol compounds, in particular those on the basis of amino carboxylic acid, hydroxy carboxylic acid, polycarboxylic acid, polyoxycarboxylic acid, phosphonic acid, amino phosphonic acid, hydroxy phosphonic acid, tannin and/or gallic acid, particularly preferably those on the basis of citrate, gluconate, glucoheptonate, heptonate and/or 1-hydroxyethane-(1,1-diphosphonic acid) may occur. As solubility promoters, if necessary also at least one compound e.g. selected from cumolsulfonates, phosphonic acid esters, salts of a carboxylic acid and/or polyvalent alcohols may be present. Moreover, often impurities in a range of 0.001 to 5 g/L occur during use, in particular often anionic impurities such as e.g. oil components.

If a silane is added to an aqueous activation composition B), care has to be taken to ensure that this silane is compatible with the corresponding pH value, which in the case of most aqueous activation compositions does not require any measures.

### Surprising Effects:

It was surprising that with an additive of a silane in an aqueous cleaning composition, the formation of pinholes could be suppressed and permanently prevented, so that on the one hand the surfaces phosphated with a zinc phosphating solution and on the other hand the surfaces pretreated with an aqueous conversion solution containing silane and titanium and/or zirconium could be kept free from pinholes, strip-shaped marks and dusty coverings on a permanent basis, so that also the phosphated surfaces provided with an electrodeposition paint, a powder paint and a wet paint and, if necessary, further varnish layers, could be formed to be without faults.

It was also surprising that by using an additive of a silane in an aqueous rinsing liquid, in particular after cleaning in an aqueous cleaning composition with or without a silane additive, and if necessary prior to activation in an aqueous activation composition with or without a silane additive prior to a subsequent phosphating process and, if necessary, prior to pre-treatment with a manganese or zinc phosphating solution or prior to contacting with an aqueous conversion solution containing silane and titanium and/or zirconium, the formation of pinholes could be suppressed and prevented on a permanent basis, so that on the one hand the surfaces phosphated with a zinc phosphating solution and on the other hand the surfaces pretreated with an aqueous conversion solution containing silane and titanium and/or zirconium, could be kept free from pinholes, strip-shaped marks and dusty coverings on a permanent basis, so that also the phosphated surfaces provided with an electrodeposition paint, a powder paint or a wet paint and, if necessary, also with further varnish layers, could be formed to be without faults.

It was also surprising that by means of an additive of a silane in an aqueous activation composition, the formation of pinholes could be suppressed and prevented on a permanent basis, so that the surfaces pretreated with a zinc phosphating solution could be kept free from pinholes, strip-shaped marks and dusty coverings on a permanent basis, so that also the phosphated surfaces provided with an electrodeposition paint, a powder paint or a wet paint and, if necessary, further varnish layers, could be formed to be without faults.

It was also surprising that by means of an additive of a suitable silane, the frequency of pinholes could be significantly reduced and partially even be prevented altogether, so that the phosphated surfaces could be permanently kept free from pinholes, but partially also from weaker strip-shaped marks or free from these marks and with weaker dusty coverings or could be permanently kept free from these coverings, so that also the phosphated surfaces provided with an electrodeposition paint, a powder paint or a wet paint and, if necessary, further varnish coatings could be formed to be without faults.

It was further surprising that the addition of a silane in particular to an aqueous activation composition led to a further reduction of the average crystal size, e.g. by approx. 20%, in particular on aluminium alloy surfaces of the phosphate layer, which improved the phosphating result even further.

It is expected that the method according to the invention leads to a further improvement of process security and ecological friendliness, whilst the handling of toxic chemicals by workers on conversion coating lines is prevented, since so far usually only the composition for conversion coating and/or the baths with an aqueous cleaning composition, with an aqueous rinsing liquid and/or with an aqueous activation composition, which are located upstream thereof, were modified by adding toxic nitrite. However, as shown in the comparative example, the addition of nitrite only allows the formation of pinholes, but not the formation of strip-shaped marks and/or of dusty coverings on phosphate layers to be suppressed or prevented.

The metallic substrates coated using the method according to the invention can be used in the automotive industry, for rail vehicles, in the aerospace industry, in apparatus engineering, mechanical engineering, in the construction industry, in the furniture industry, for the production of crash barriers, lamps, profiles, facings or small parts, for the production of vehicle bodies or vehicle body parts, of individual components, preassembled or connected elements preferably in the automotive or aviation industry, for the production of devices or systems, in particular of domestic appliances, control mechanisms, testing facilities or construction elements.

### EXAMPLES AND COMPARATIVE EXAMPLES

The examples (B) according to the invention and the comparative examples (VB) as described below are given in order to explain the subject matter of the invention in more detail.

The aqueous bath compositions are produced as mixtures of an aqueous activation composition A) having a content of 0.9 g/L of zinc phosphate particles with an average particle size of less than 1 μm, measured using the Zetasizer from Malvern, 0.037 g/L sheet silicate on the basis of hectorite, 0.15 g/L dispersing agent on the basis of polyacrylate and 0.003 g/L of biocide both with and without an additive according to table 1, using non-prehydrolysed or prehydrolysed silanes. Many mixtures each contain a silane and, if necessary, also contents of at least one second similar silane and here, too, the simple term silane is used rather than silane, silanol and/or siloxane. Prehydrolysis can, depending on the silane, also last over several days at room temperature under vehement stirring, provided the silanes to be used are not already present in a state prehydrolysed by the supplier. For the prehydrolysis of the silane, the silane is added in an excess amount into water and is, if necessary, catalysed using acetic acid. Acetic acid was added only in individual embodiment variants purely for adjusting the pH value. In some embodiment variants, acid is also included as a catalyst for the hydrolysis. A short-chained alcohol may be formed during the hydrolysis, which was however not added. The finished mix was used in its fresh state.

The following was used in the laboratory for each test (=per example or comparative example) and for each surface material: three sheets of cold-rolled steel CRS Gardobond® C, steel Gardobond® G, electrolytically galvanised on both sides, steel Gardobond® EA, hot-galvanised on both sides, and aluminium AA6014 Gardobond® 6014 from Chemetall GmbH.

The sheets were initially cleaned with an aqueous cleaning liquid Gardoclean® 854/5 from Chemetall GmbH with a pH value of 10.5 by submersion at 60° C. over 10 minutes, and immediately afterwards rinsed with mains water for 30 seconds by submersion at room temperature. Activation was subsequently carried out using an aqueous activation composition A), which had previously been added in a liquid form to demineralised water with a 3 g/L activation concentrate Gardolene® V 6559 of Chemetall GmbH.

This aqueous activation starting composition, which had been prepared for activation, without a content of silane, silanol and/or siloxane, was used to treat additional sheets in order to initially check whether a larger number of clearly visible and larger pinholes is formed with the activation composition thus adjusted and under these conditions. Since pinholes sometimes develop only under certain activation conditions, which is also dependent on the amount and type of impurities on the used sheets and in the bath composition, the electric conductivity of the activation bath was adjusted to values in a range of μS/cm to 2000 μS/cm by adding sodium and/or potassium orthophosphates, and the pH value was adjusted to a range of 8 to 9.5 by adding caustic soda. If necessary, also the temperature was adjusted to values in a range of 20 to 50° C., so that with an activation composition adjusted in this way, a greater number of clearly visible and larger pinholes is formed under the bath conditions. The reason is that extreme conditions are to be established as initial conditions for the formation of pinholes, in order to determine clear differences.

This activation starting composition was, after this basic adjustment, kept as long as possible for the activation of all sheets from all material variants and for as many additive variants as possible, which were each added to part of this adjusted starting composition.

When it was shown during the further tests that the formed pinholes were not sufficient in number and size under the above-mentioned conditions, the starting composition was readjusted by adjusting their electric conductivity by adding sodium and/or potassium orthophosphates to values in a range of 2000 to 4000 μS/cm and their pH value was adjusted to a range of 9.5 to 10.5 by adding caustic soda. If necessary, also the temperature was again adjusted to values in a range of 20 to 50° C., so that with the activation composition adjusted in this manner, under bath conditions, a larger number of clearly visible and larger pinholes develop.

For activation with the aqueous activation composition, which was in each case adjusted and, if necessary, varied by means of at least one additive according to the table 1, work was in each case carried out using submersion for 30 s. Immediately afterwards, zinc phosphating was carried out without intermediate rinsing using Gardobond® R 2600 from Chemetall GmbH. Subsequently, the next activation attempt was made with another silane-containing activation composition on the next sheets.

The sheets zinc-phosphated using an aqueous zinc manganese nickel phosphating solution (tri-cation phosphating) Gardobond® R 2600 of Chemetall GmbH over 3 minute submersion at 55° C. were subsequently rinsed for 10 seconds using mains water and then 10 seconds in demineralised water and were subsequently dried in a drying cabinet for 10 minutes at 105° C. All the phosphate layers were almost closed, very fine-grained and fault-free, apart from the indicated errors in respect of the frequency and size of pinholes, of the more or less pronounced formation of strip-shaped marks and of dusty coverings, which were lying loosely on the otherwise fault-free zinc phosphate layer and could easily be wiped off. These errors were determined and evaluated with the naked eye after phosphating or after rinsing or after drying.

TABLE 1
The effect of various additives on an activation composition A) with statements
regarding frequency and size of the pinholes, with respect to the frequency and intensity
of strip-shaped marks and with respect to the intensity of dusty coverings, with the
number of crosses indicating the intensity, frequency and size of the imperfections:

| | | | Frequency, Size and/or | | |
|---|---|---|---|---|---|
| B/ | | Additive | Intensity of | | |
| VB | Additive | in g/L | Pinholes | Strips | Dust |
| VB0 | — | 0 | xxx | strong | xxx |
| VB1 | Dimethylethanolamine | 0.500 | xxx | weak | xxx |
| | | 1.000 | xx | weak | xxx |
| VB2 | Na salt of the ethylenediaminetetraacetic | 0.050 | xx | weak | xxx |
| | acid | 0.150 | xxx | weak | xxx |
| | | 0.350 | xxx | none | xxx |
| VB3 | Methyl diethanolamine | 0.500 | x | weak | xxx |
| | | 1.000 | x/— | weak | xxx |
| VB4 | Sodium nitrite, calculated as NO₂ | 0.120 | — | weak | xxx |
| VB5 | Tetrapotassium pyrophosphate | 1.000 | x | weak | xx |
| VB6 | 3-aminopropyltriethoxysilane, not | 0.050 | xxx | strong | xxx |
| | prehydrolysed | 0.100 | xxx | strong | xxx |
| | | 0.250 | xxx | strong | xxx |
| | | 0.400 | xx | strong | xxx |
| | | 0.700 | xx | strong | xxx |
| VB7 | 3-glycidoxypropyltrimethoxysilane, not | 0.100 | xx | weak | xxx |
| | prehydrolysed | 0.500 | xx | strong | xxx |
| VB8 | 3-glycidoxypropyltrimethoxysilane | 0.800 | xxx | strong | xxx |
| | prehydrolysed | | | | |
| VB9 | Gamma-ureidopropyltrimethoxysilane | 0.200 | xx | weak | xxx |
| | | 0.500 | xx | weak | xxx |
| B1 | Bis(trimethoxysilylpropyl)amine, not | 0.050 | xxx | weak | x |
| | prehydrolysed | 0.200 | xx | weak | x |
| | | 0.500 | xx | weak | x |
| | | 1.000 | — | weak | x |
| B2 | N-(3-(trimethoxysilyl)propyl)ethylene | 0.050 | — | — | x |
| | diamine, not prehydrolysed | 0.500 | — | — | — |
| | | 1.000 | — | — | — |
| B3 | N-(3-(trimethoxysilyl)propyl)ethylene | 0.014 | xx | strong | xxx |
| | diamine, prehydrolysed | 0.028 | xx | strong | xx |
| | | 0.054 | x | weak | xx |
| | | 0.080 | x | weak | x |
| | | 0.100 | x | weak | x |
| | | 0.200 | — | weak | — |
| | | 0.500 | — | — | — |
| | | 1.000 | — | — | — |
| B4 | 3-[2-(2-aminoethylamino)ethyl- | 0.050 | — | weak | x |
| | amino]propyl-trimethoxysilan, not | 0.3 | — | weak | — |
| | prehydrolysed | 0.5 | — | — | — |
| B5 | 3-aminopropyltriethoxysilane + | 0.140 + | — | weak | — |
| | N-(3-(trimethoxysilyl)propyl)ethylene | 0.048 | | | |
| | diamine, both prehydrolysed | 0.420 + | — | — | — |
| | | 0.144 | | | |

Table 1 demonstrates that the activation compositions B) examined under comparable conditions may, depending on the type and amount of additive, have clearly different effects on the various fault types. It was shown that the amines used may have a limited positive effect on the frequency of pinholes and/or on the intensity of strip-shaped marks, but not on the formation of dusty coverings. It is also shown that an additive of nitrite may have a very positive effect on the frequency and size of pinholes, but a limited positive effect on the intensity of strip-shaped marks and no effect on the formation of dusty coverings. It was further shown that an additive of tetrapotassium pyrophosphate only has a limited positive effect on all of these three fault types.

If instead of these compounds in each case one or two silanes are added, then this can lead, in the case of some silanes, to a limited positive effect on all three fault types and, with some silanes, to a very positive effect on all three fault types, depending on the additive and depending on whether the additive was prehydrolysed or not. There were indications that silanes, silanols and/or siloxanes with more than one amino group have a better effect on the prevention of imperfections during cleaning, rinsing and/or activating and are therefore particularly suitable in the method according to the invention.

1.-17. (canceled)

18. A method of preventing pinholes on a zinc-containing metallic surface comprising the steps of:
applying to the zinc-containing metallic surface an aqueous composition comprising water and a silane additive, wherein the aqueous composition is selected from the group consisting of a cleaning composition, a rinsing liquid which is used a) prior to a cleaning process, b) amidst a plurality of cleaning zones, c) immediately after a cleaning process and/or d) the liquid is used for cooling, and an activation composition, wherein the silane additive comprises at least one member selected from the group consisting of a silane, a silanol and a siloxane, and wherein the silane additive is present in the aqueous composition in a range of from 0.001 to 5 g/L, calculated in relation to the respective silane.

19. The method according to claim 18,
wherein the cleaning composition is a cleaning bath;
wherein the rinsing liquid is a rinsing bath; and
wherein the activation composition is an activation bath.

20. The method of claim 18, wherein the aqueous cleaning composition in a cleaning zone;
wherein the rinsing liquid is in a rinsing zone; and
wherein the activation composition in an activation zone of a treatment line.

21. The method of claim 18, wherein the aqueous composition further comprises a content of fluoride, a titanium complexing fluoride, a hafnium complexing fluoride and a zirconium complexing fluoride.

22. The method of claim 18, wherein the aqueous composition further comprises a metal cation, an organic polymer, an organic copolymer and an additive.

23. The method of claim 18, wherein said method is conducted prior to an alkaline, neutral or acidic aqueous passivation, and wherein the aqueous composition further comprises at least one member selected from the group consisting of a metal cation, a complex fluoride, an oxide, phosphate, silicate, organic polymer, an organic copolymer and an additive.

24. The method of claim 18, wherein the aqueous composition is applied prior to an alkaline phosphating, a manganese phosphating or a zinc phosphating.

25. The method of claim 18, wherein the activation composition comprises metal phosphate particles of divalent or trivalent metals with an average particle grain size of up to 3 μm and of at least one further substance selected from the group consisting of a dispersing agent, a thickening agent, a surfactant and an additive.

26. The method of claim 18, wherein the activation composition comprises on the basis of 0.001 to 10 g/L of a colloidal titanium phosphate, of 0.005 to 30 g/L of orthophosphate dissolved in water and of at least one further substance selected from a condensed phosphate, a surfactant, a stabilizing agent, a thickening agent and a biocide.

27. The method of claim 18, wherein the rinsing liquid has a pH value of from 3 to 14.

28. The method of claim 18, wherein the cleaning composition has a content of heavy metal ions, a content of a complexing agent.

29. The method of claim 18, wherein the cleaning composition has a pH value in a range of 3 to 14, an wherein the cleaning composition further comprises a surfactant in a range of 0.01 to 10 g/L, wherein the surfactant comprises a non-ionic surfactant.

30. The method of claim 18, wherein during production of the aqueous composition the silane additive comprises at least one member selected from the group consisting of an alkoxy group, an amido group, an amino group, a urea group and an imino group.

31. The method of claim 18, wherein during production of the aqueous composition the silane additive comprises at least two amino groups or at least two alkoxy groups.

32. The method of claim 18, wherein during production of the aqueous composition the silane additive contains is an alkoxy silane, alkoxy silanol or alkoxy siloxane comprising at least one group selected from the group consisting of an amido group, a urea group and an imino.

33. The method of claim 18, wherein during production of the aqueous composition the silane additive is selected from the group consisting of an alkoxy silane, an alkoxy silanol and an alkoxy siloxane having at least two amino groups per molecule.

34. The method of claim 18, wherein during production of the aqueous composition the silane additive is selected from the group consisting of:
3-[2-(2-aminoalkylamino)alkylamino]alkyltrialkoxysilane,
4-amino-dialkylalkyltrialkoxysilane,
4-amino-dialkylalkylalkyldialkoxysilane,
aminoalkylaminoalkyltrialkoxysilane,
aminoalkylaminoalkylalkyldialkoxysilane,
aminoalkyltrialkoxysilane,
bis-(trialkoxysilylalkyl)amine,
bis-(trialkoxysilyl)ethane,
gamma-aminoalkyltrialkoxysilane,
gamma-(trialkoxysilylalkyl)dialkylene triamine,
gamma-ureidoalkyltrialkoxysilane,
N-2-aminoalkyl-3-aminoproplyltrialkoxysilane,
N-(3-(trialkoxysilyl)alkyl)alkylene diamine,
N-alkylaminoisoalkyltrialkoxysilane,
N-(aminoalkyl)aminoalkylalkyldialkoxysilane,
N-beta-(aminoalkyl)-gamma-aminoalkyltrialkoxysilane,
N-(gamma-trialkoxysilylalkyl)dialkylene triamine and
poly(aminoalkyl)alkyldialkoxysilane.

35. The method of claim 34, wherein the alkyl groups are independently selected from the group consisting of methyl, ethyl and propyl.

36. The method of claim 18, wherein during production of the aqueous composition the silane additive is based on a member selected from the group consisting of bis(trialkoxysilylpropyl)amine, N-(3-(trialkoxysilyl)propyl)ethylene diamine and 3-[2-(2-aminoalkylamino)alkylamino]propyltrialkoxysilane.

37. A metallic substrates prepared according to claim 18.

38. The metallic substrate according to claim 37, wherein the substrate is in the form of an automobile body part, a rail vehicle, an aerospace vehicle, an engineering apparatus, a construction, furniture, a crash barrier, a lamp, a profile, a facing, an aviation vehicle, a household appliance, a control unit, a testing unit, a small part and a construction element.
